(19) United States
(12) Patent Application Publication
(10) Pub. No.: US 2011/0288969 A1
(43) Pub. Date: Nov. 24, 2011

(54) ASSET RECORD OWNERSHIP SYSTEM

(76) Inventor: Chad R. Wiech, Burnsville, MN (US)

(21) Appl. No.: 12/785,230

(22) Filed: May 21, 2010

(51) Int. Cl. G06Q 10/00; G06F 17/30; G06Q 20/00

(52) U.S. Cl. 705/30; 707/802; 707/E17.044

(57) ABSTRACT

A computer system adapted to implement a method for creating and interacting with an Asset Record Container (ARC), the method comprising providing an information container representing a piece of real property identified by a unique identifier, providing an information transaction history representing information related to the input and output of the real property information stored by the ARC, providing an ARC web portal manager adapted to allow the owner of the real property represented by the ARC to manage access to the real property information and allowing for communication and integration with third party applications, providing access to the ARC according to the plurality of ARC access rules of the ARC web portal virtual manager; and providing a payment transaction processing system adapted to handle receipt and payment of transaction fees relating to creating and interacting with the ARC.

### BACKGROUND OF THE INVENTION

Real estate as an asset class lacks transparency by nature. A shortage of information control and integrity are contributing factors to this lack of transparency. Owners and participants in the real estate market continue to encounter problems related to information control, integrity and transfer. These problems consume many unnecessary human and capital resources.

Overly fragmented information and relationships lack integrity. This lack of integrity is a primary reason real estate owners and participants have difficulty gauging risk. The perception of risk creates a breakdown in the system.

Without knowing the human source of a particular component of information it is impossible to trust. The ability to function in the real estate marketplace will continue to be difficult as long as information integrity and control is creating risk. If market participants cannot validate the accuracy of the information presented to them they are generally forced to ignore it or hire a practitioner to recreate it.

To be successful in real estate, an owner must become an expert at obtaining timely, credible and complete information. The poor transfer of critical property information restricts a buyer's ability to quickly gather credible and complete information.

Researching and documenting a single property's information is done over and over by different ownership, practitioners and vendors, many times without the knowledge of previous research and documentation. An appraiser by example contacts; brokers, surveyors, engineers, architects, accountants, building inspectors, tenants, attorneys, and property managers during the process of completing a typical commercial appraisal assignment These contacts are made to find all of the information that the owner has lost control over. Even when pertinent property information is transferred, it is often in a printed or static format.

Re-keying information and recreating documents is common in the real estate market. Even after the owners pay for these costly and redundant efforts, the information often remains incomplete or worse yet, wrong. Considering the magnitude of the United States real estate capital asset market, operating with incomplete and untraceable information jeopardizes the entire economic system.

Data is gathered from public or private third party data aggregators is impossible to trace back to the individual who created it. Trusted information must come from a credible source, most often from a licensed practitioner. The inability to identify and challenge the human source of information produces an attractive opportunity for fraudulent shortcuts and errors Real Estate services providers produce credible information that is poorly organized after conveyance. Information seldom ends up in a mechanism that allows the current owner to convey it to the next owner along with its source.

There currently isn't a permanent mechanism that ties an individual to the information they disseminate throughout a property's life cycle. Without such a mechanism, information integrity will be impossible to implement considering the number of properties, practitioners and gross amount of information generated every day by both.

As a general rule, real estate is also a fairly illiquid asset class when compared to other investments such as common or preferred stock, bonds or commodities. This illiquidity is caused in part by a lack of transparency surrounding a property's information.

Successful real estate investment, lending and ownership include confirming that a property is what has been represented. Factors often considered include elements of building construction, land sizes, dimensions, setbacks, environmental conditions; and so forth.

Additionally, a prudent real estate buyer's legal counsel must examine the underlying real estate title and confirm that the property is free of legal liabilities. Further an investor must have evidence of liens and easements encumbering the subject property. This process of a buyer collecting information and reviewing all facets of a property prior to acquisition is referred to as “due diligence”.

The universe of real estate owners include those that acquire property for their own use, requiring verification that the property is suitable toward that use, or for investment purposes, requiring verification of adequate financial information to establish the expected rate of return. The scope of due diligence depends upon the objectives of the party conducting the investigation. The current owner must understand that the potential buyer and their lender must satisfy all issues material to the buyer's objective, including a complete analysis identifying the transaction's risks and opportunities within the deal that might help mitigate risks. Currently the owner searches around various sources to compile all the requirements of a typical lender, buyer, or other practitioner. For example: If there are buyers with multiple offers or multiple lenders bidding on a loan, all of the same information has to be packaged, and conveyed multiple times to all interested parties.

There are several places where an owner would typically store property information including their personal computer, an office hard drive, off site backup servers, cloud computing storage systems or in paper form filing cabinets.

To transfer documents electronically owners generally email files to interested parties, vendors and lenders. Many real estate documents are large and push the limits of email size restrictions. To circumvent these limitations, property owners regularly email files one at a time. Third party services can also be used, such as http://www.yousendit.com. These processes are very time consuming and inefficient.

If the owner has documents in physical form, such as appraisals, environmental reports, surveys and so forth, they will typically scan them before completing the above process or be forced to mail a physical copy or even originals. Many times physical documents get distorted or lose readability when copied or scanned in preparation for these transmittals.

Partnership and shareholder access and reporting are often done through electronic mail or via physical delivery. This onerous system of transfer causes inefficiency and increases the cost of doing business and puts undue stress on property owners and managers.

Shareholders in ownership mechanisms such as Real Estate Investment Trusts must process information from many sources regarding a property's construction, leasing and operation. The operation information like annual budgets, long term building improvement plans, capital expenditure forecasts, project management, and investment analysis can require a shareholder to review pages of printed text or be linked to various internal or external e-documents.

Over time, property information and the corresponding contacts end up in various places, piles and files because there is no standard retention mechanism or method. The lack of control owners have over their information is profound. A need exists to integrate credible property information within a permanent vehicle for the entire life cycle of a property.

The function of a real estate appraiser is to certify a property's value and communicate that value to the client. To determine value, there are three approaches considered; the cost approach, the sales comparison approach, and the income approach. These approaches require appraisers to gather information from multiple sources and understand the property in great detail.

The fragmented nature of information in the real estate industry, forces appraisers to spend the majority of their time and their client's money on gathering information which already exists but is scattered between owners, property managers, previous service providers, prior owners, current vendors and government agencies.

An appraiser must locate blue prints for details of construction with improvement square footage, accounting documents such as tax returns and depreciation schedules, government records on taxation and so forth prior to beginning work estimating value. This information collection process is massively redundant and creates nothing new; it wastes time which could be used to calculate the cost approach, the sales comparison approach, and the income approach to value.

The inefficient time spent recreating information pushes the price an owner pays for an appraisal to a much higher level than would be necessary if the owner had immediate access to all of this information.

The accuracy of information is essential in developing creditable valuations which underpin the entire American Real Estate market. Considering the weight placed on the appraised value by lenders, the fact that appraisers are sometimes forced to use data which has an unknown source is troublesome. The proliferation of unconfirmed data creates a true need to have accountability back to the source.

Over time it is inevitable that a property will be appraised multiple times. Different appraisers appraising the same property is common place. This happens when a new owner or lender wants a different opinion or more often because they do not know who completed previous appraisals for prior lenders or owners. Efficiency would be realized by a property owner or lender if they hired an appraiser familiar with the property's salient facts.

Third party information aggregators, whose core customers are appraisers, do not provide the appraiser with nearly the depth and breadth of information needed. Fragmented information in the real estate industry is a major quality control issue for appraisers.

Real Estate brokers are contracted to sell, purchase, or lease property. The collection of a property's information is a common task before any deal-making can begin.

Brokers contracted to sell real estate need to first know what they have to sell. This means that they must go through substantial due diligence and analysis of the subject property. This includes gathering information, taking photos, establishing an underwriting information file, creating a demographic and market information report and capturing prior years' operating documents. Information brokers gather is typically entered into an internal system. If the broker does not have quick access to complete, accurate information, it will impact the timeliness and cost of the owner's desired transaction.

Brokers contracted to assist a buyer or lessee with an acquisition also go through substantial analysis, and research multiple properties for suitability purposes. This process starts with identifying the buyer's parameters. Once identified, the broker searches the market for properties that meet the criteria. Once properties are identified, the broker gathers all of the relevant information from the listing agent and a letter of intent is created. During the due diligence period the brokers work together to gather and convey all appropriate information required by the buyer. If adequate information is not available the prospective buyer will typically begin the process over with another suitable property. If adequate information is available to satisfy the buyer the transaction moves forward to a closing.

After the closing the information generally stays in the computer server of the previous owner or brokerage firm. There is generally little or no motivation to locate any of the information assembled over the previous years of operation for the new owner. The new owner is then required to contract with vendors to complete documents like surveys, architectural drawings and environmental reports which are time intensive and costly.

Banks and institutional lenders also demand property information when making a loan decision. This definitely includes an appraisal and a title commitment. Often lenders are seeking many other pieces of property information. Documents will typically come from sellers in static document formats. The reentry of this static information to the lender's internal system is time consuming and prone to error. The lender's difficulty in obtaining and entering creditable information is a major problem in the lending industry.

All things being equal, the more credible information a lender has to base their decision, the better their decision will be. If lending institutions had a more efficient way to gather property information up front.

A need exists for a lender controlled mechanism which would allow the lender to place a lien on all of the existing information as they do with the lien (mortgage) on the physical property. In case of foreclosure the lender needs all of the contacts and information on the property. This would give lenders considerably more power, by having all the property documents and the relationship history one place. If this need was filled, lenders would have much more viable, liquid assets to put back on the market and they would be able to better maintain properties with access to important contacts and pertinent information.

Property Management Companies have a need to collect and maintain information and relationships. Management tasks include leasing, rent collection, property vendor management, tenant interaction, accounting, budgeting, reporting and the like. There are several property management software solutions that are used in the market today which effectively solve internal management challenges. Many owners use Property Management Companies to communicate with vendors and practitioners. Disseminating information to vendors and practitioners out of internal management systems is still cumbersome and is generally completed in much the same method as banks use, one email at a time. Some more sophisticated property owners have created websites for individual properties, which is costly, time consuming, and may require additional staff or long-term maintenance contracts. There is a need for an interactive solution which connects practitioners and vendors to information about a particular property.

There are many software systems for the real estate market. The owner often depends on others who control, integrate and convey information and relationships input to and output from these systems. There is a need for improved information control, transparency, integrity and transfer.

A method to which the invention relates is the storage of information and the ability for stakeholders surrounding the property to communicate. This is narrowly addressed by U.S. Pat. No. 7,143,048 (multi-tenant application) and U.S. Pat. No. 7,464,109 (financing application). The quality of information and communication directly correlates to the quality of individuals submitting and partaking in it. While U.S. Pat. Nos. 7,143,048 and 7,464,109 satisfy the need for storage of documents and communication, they do not place emphasis on any process that infuses accountability and information integrity. The risk involved in relying on information and communication is mitigated when practitioners interact. Additionally, the ability to convey information and relationships as a property trades hands is not addressed. Without conveyance, major long-term inefficiencies throughout the life cycle of the property will be realized.

Information aggregation and dissemination is accommodated by U.S. Pat. No. 7,254,559. There is a wealth of information that is available in the public sphere. CoStar Group Inc. (Patent Assignee) captures it and provides market statistics, analysis and listing services for real estate professionals. Although this service is focused on real estate information, it is very different from the invention. The end users of the U.S. Pat. No. 7,254,559 method are left with untraceable and uncertified information. Typically end users are real estate professionals; however property owners may also interact with the CoStar system. Through U.S. Pat. No. 7,254,559, property owner's ability to claim ownership of information pertaining to their property as a personal property asset is not addressed.

Capturing information surrounding a specific asset is discussed in US 2002/0032626. This patent contemplates the idea of a global registry, much like the Department of Motor Vehicles provides a registry for vehicles. U.S. Publication 2002/0032626 fails to capture the concept of information certification for the accuracy of the information input into the registry. This patent also does not consider a mechanism to transform information into a conveyable personal property asset. Additionally, US 2002/0032626 does not address the conversion of standardized information into other standards or the reconciliation of any conflicting information that arises from the conversion process. The conversion and reconciliation processes increase efficiency and reduce incorrect information in the market.

Online listing services are abundant in the real estate market. U.S. Pat. No. 6,883,002; US 2008/0288336, US 2005/0010423, US 2005/0240429 and US 2009/0240550 all provide services to list properties for sale. These patents provide owners and practitioners several tools to sell their property on a national basis. The invention will not directly compete with these patented tools, but instead interact allowing ARC users to further benefit from the above mentioned prior art.

Electronic transaction services provide real estate stakeholders with the ability to communicate and virtually complete real estate transactions. Patents and prior art that relate to this services include: U.S. Pat. No. 7,596,511; US 2003/0033241; US 2004/0049445; U.S. Pat. No. 6,594,633; U.S. Pat. No. 7,548,884; US 2007/0271155; US 2005/0288955; US 2006/0155570 and US 2007/0271155. These services focus on the transaction of a product or service and the subsequent steps that are necessary to complete that transaction. The long term continuance of ownership of the information and relationships is not considered in the prior art. Once these systems are finished with a transaction the information gathered effectively dissipates, often creating a need to recapture much of the same information.

The lack of verifiable information is another issue these services do not solve. The ability to transact physical objects in a virtual world is efficient. However, the ability of these tools to create more efficient transactions, may have negative affects as they place less focus on information integrity. The focus on transaction frequency often creates the disconnect between a property's information and its creditability. This disconnect translates to faster deal closings which can bypass the valuable confirmation steps needed in verifying information that will certainly be required later in the properties management lifecycle. Million Zillion Software, Inc. has a broad scope transaction model dealing with the concept of hybrid commerce in the areas of paintings, jewelry, collectables, customs, people, nature and sciences. Million Zillion Software, Inc's hybrid commerce model includes a category for users to be a seller, creator, collector or inspector of personal property. This model does not include financial payments for the creator, collector or inspector. Further, the model does not take into consideration the harmonization of real estate standards or a medium for real property information reconciliation. Additional electronic transaction prior art includes ZIGLIB, Zbigniew Karwowski's Intellectual Foundation focused on hybrid commerce education.

A need remains for a tool that regularly compensates practitioners for providing verifiable information.

A need also exists for a real estate an information reconciliation platform where human inputs can be compared against other human inputs. This second layer of information credibility would improve the decision quality and has not been considered by the prior art herein.

Technology has progressed significantly in recent history. Some of the greatest leaps have been made in analysis tools. Real Estate software from companies like Argus®, Yardi® and Intuit® provide tools which position property owners and managers with a better understanding of their assets. The tools have the ability to generate reports which are output in various file formats. Most of these formats are in a fixed form to prevent tampering and are stored by users in various locations including email servers, local hard drives, paper printouts and removable or off site hardware.

Real estate report generation has been around for many years. Appraisers, Realtors, Architects, Surveyors, Engineers, Accountants and many others generate reports which can add value to their subject. A report in the United Kingdom called Housing Information Packs (HIPS) is required by the government prior to listing residential real estate for sale. The providers that prepare these reports typically submit them in a printed or digital of format. A need exists for a permanent medium where the owner maintains these reports along with other valued property and relationship information which accepts updated inputs and allows for output.

Several existing solutions serve their specific purpose, yet they fall short in solving the problems for which the invention was created.

### SUMMARY OF THE INVENTION

A need still exists for an invention that accommodates real estate information ownership, control, integrity and transfer. The present invention satisfies these needs. In the description summarized below, the preferred embodiment of the present invention is preferred to as the Asset Record Container™ (ARC).

Improved Real Estate information control, integrity and transfer are accommodated through the present invention. The ARC transforms information centric to a subject real property into an asset owned as chattel.

The present invention allows a property owner to direct, communicate, and convey property information and its human sources. The Asset Record Container adds value, transparency and marketability to its subject real property.

At inception each ARC is assigned a unique identification number by the Administrator. This Unique ID system together with an ARC Title system provides the mechanism for legal ownership control, which allows the ARC to be sold or used as collateral. Subject property ownership is verified by a third party, Certified Practitioner.

The Owner controls access and permissions through a virtual web portal manager within the ARC. Each container is loaded with subject property specific information by Owners, Practitioners and Vendors and becomes personal property (chattel).

The invention links information to Certifying Practitioners and Vendors who are accountable through the life cycle of the ARC. Certified Practitioners include, but are not limited to: Realtors®, Appraisers, Architects, Engineers, Surveyors and Accountants. The Administrator confirms that these certifying Practitioners are licensed in their respective fields and members of a trade organizations with a mandatory code of ethics ensuring honesty and integrity. The Owner of each ARC pays an annual administration fee which is partially distributed to the Certified Practitioner for certifying ownership and maintaining correct information in the ARC.

Vendors linked to the present invention include, but are not limited to: Banks and other Lenders, Asset Managers, Facilities Managers, Property Insurance Companies, Title Insurers, Attorneys, Government Agencies and Valet Service Providers. These Vendors participate in an efficient means for communication and information transfer.

Usefulness and relevance are continuously enhanced by integrating application tools, analytics and gadgets produced by application entrepreneurs. Owners' access these applications through a digital marketplace hosted by the administrator. The invention interacts with virtually all other digital property information and contact management devices. Existing software and management systems accept inputs from and generate outputs to the ARC. The invention accepts inputs and generates outputs in a multitude of formats.

The present invention includes a historic information deposit and withdrawal record. Inputs are time stamped and capture the information source which is permanently maintained in the historic record. This history record provides information accountability throughout the ARC life cycle.

The ARC contains a mechanism which translates information from one accepted real estate standard to other competing standards on behalf of the owner. The ARC also allows for a reconciliation of conflicting information

Within the ARC communication is accommodated between Practitioners, Owners and Vendors. Owners can also publish information publicly using a custom MicroSite.

The invention includes a computer system having at least a processor coupled to a memory and configured to execute an Asset Record Container (ARC) program, a secure ARC web portal program and a payment transaction processing program having computer executable instructions, the computer executable instructions adapted to be executed to implement a method for creating and interacting with an Asset Record Container, the method comprising providing, via the ARC program, an Asset Record Container (ARC) comprising, providing a unique identifier adapted to store a unique identifier representing a piece of real property, providing an Asset Record Container adapted to receive and store information related to the piece of real property identified by the unique identifier, providing an ARC information transaction history adapted to store information related to the input and output of the real property information stored by the ARC, providing an ARC web portal manager adapted to allow the owner of the ARC to manage access to the real property information stored by the ARC utilizing a plurality of ARC access rules; and providing an ARC external application interface adapted to allow for communication with third party applications, providing, via the ARC web portal program, a secure ARC web portal adapted to provide access to the ARC according to the plurality of ARC access rules of the ARC web portal manager; and providing, via the payment transaction processing program, a payment transaction processing system adapted to handle receipt and payment of transaction fees relating to creating and interacting with the ARC.

The method further comprising providing a deposit management system capable of receiving and storing information that is submitted using a keyboard, fax, telephonic communication, Simple Message Service, Multimedia Messaging Service, electronic mail or File Transfer Protocol and is capable of receiving and storing information in a variety of formats including document formats, image formats, audio/video formats.

The ARC may be further adapted to receive and store information selected from the group consisting of vendor information, practitioner information, property information and relationship information.

In various embodiments, an Asset Record Company acts as a keeper for each instantiation of an ARC. In various embodiments, the Asset Record Company may implement additional security measures to ensure that the information contained within the ARC is secure.

In certain embodiments, an ARC is created for each property. The ARC can then be populated with relevant data. At creation, each ARC is assigned a Unique ID which may be a unique series of digits or a series of digits combined with a standardized code, such as country code.

In various embodiments the ID Mechanism provides a System for legal ownership. Each ARC has an owner like real property and can be leveraged or included as collateral in a promissory note. In addition, the ARC may include Legal owner controls access and permissions, thus allowing the owner of the ARC to limit access to data stored within the ARC.

In certain embodiments, the ARC includes a proprietary system of secure commands allowing the owner access to their specific Asset Record Container through a secure web portal. This way, the owner may quickly access the ARC directly, bypassing other available modes of access including proxies, redirects or alternative ARC front-ends.

In various embodiments owners may expand the features of the base ARC system. Thus, in various embodiments, owners may download additional applications that manipulate data stored within the ARC or add other additional functionality. For example, various software and data management tools may seamlessly interact with the ARC. Thus, various embodiments of the invention encourage digital application entrepreneurs to add value and earn compensation constructing relevant tools, analytics and gadgets for ARC owners.

In certain embodiments, the ARC supports data management and data submission restrictions which allow for fine-grained control over the submission, type and certification status of data. Certain embodiments allow Owners unlimited ability to deposit data. Vendors such as Realtors®, Appraisers and the like that are engaged by the owner may be issued access to deposit data into the ARC. Vendors and other practitioners may be required to certify data that is submitted into the ARC. For example, an appraiser may certify performing an inspection and verifying ownership. In certain embodiments the ARC implements an ARC Certification rating; the data submitted are independently confirmed and formally certified. The certification rating system may include various different levels of certification including bronze, silver, gold diamond certification.

Further, Vendor's and other professional's identification data will be maintained in the ARC. Storing this data may increase data accuracy by providing a system of accountability. Further, this certification data is maintained within the ARC and thus any transfer of ownership provides Vendors and other practitioners with additional business opportunities.

The data may be submitted to the ARC in a variety of formats, including different document formats, image formats and audio/video formats. Document formats may include DOC, HTML, XHTML, XML, PDF, TXT, CSV or the like. Data submitted in XML format may comply with various data standards including OSCRE, RETS, MISMO and other real estate data standards. Image formats may include JPG, PNG, GIF, TIFF, BMP, ICO, SVG or the like. The audio/video formats may include AVI, MPEG, MOV, SWF, M4V, FLV, MP3, WAV, AC3, OGG and the like. Further, the ARC may handle files that have been compressed in a variety of formats including ZIP, TGZ, 7z, JAR and the like. Finally, in various embodiments, the ARC has a mechanism for cross conversion or transcoding from one data type into another. This allows the ARC to detect duplicate data and reduce the number of data errors. The ARC offers a medium by which multiple stakeholders can reconcile conflicting data points.

To accommodate the distribution of relevant data points, the ARC may include full featured data control and access restriction mechanism. This mechanism allows the owner to determine all access features of data stored within the ARC. For instance, the owner may allow for data withdrawal based on permissions that allow specific parties to withdraw or extract data. Further, owners may publish components of an ARC publicly or to private entities like banks or prospective tenants using a private ARC web site with its own URL. In other embodiments

In other embodiments, the invention includes communication portals for owners, interested stakeholders, vendors and practitioners to interact with the each other or directly with the ARC. For example, in one embodiment, the ARC may provide a instant chat portal where interested parties may discuss information relating to the ARC. In other embodiments, the ARC may provide a forum system such as UBB, Simpleboard, vbulletin or the like that allows for additional communication.

In various embodiments, the ARC maintains an extensive logging and tracking system that maintains information on all data submitted, verified, shown, extracted, viewed or similar. This way an ARC owner can investigate any and all transactions taking place related to the ARC. This may allow the owner to identify unauthorized access and update access permissions or take other action. In various embodiments, the owner may utilize the logging and tracking system to provide a content deposit history, which may provide account statements.

In various embodiments the ARC includes a payment system. This payment system may provide a mechanism for compensating the certifying practitioners, or other practitioners that contribute or provide data and/or services to the ARC. This may provide additional motivation toward data accuracy and historic accountability of the information contained in the ARC.

The entire ARC can be sold. This conveyance process offers owners the ability to monetize their asset. In various embodiments, the Asset Record Company maintaining the ARC provides a simple process for buyers and sellers to come together and transfer title. This process may include a formal inspection period where the ARC is put in quarantine. As part of this process the ARC may be configured into “quarantine mode” which may mask certain data contained within the arc from the potential buyers. For instance personal information such as Social Security numbers and bank account numbers may be obfuscated, masked or otherwise hidden.

In various embodiments, the seller must deliver and set terms of release, the buyer has rights of refusal and is responsible for fulfilling terms of release. Once both parties are satisfied the ARC may be conveyed to the buyer who immediately becomes new owner of the ARC and access control and other ARC rights will be transferred accordingly.

In various embodiments, the ARC may be duplicated and configured into “historic mode” which allows the prior owner or seller to retain a version of the ARC and the information contained therein. This “historic mode” may allow the prior owner or seller to submit additional transaction and post-transaction documents into the ARC for safekeeping. Further, the “historic mode” may contain a master set of data, not affected by any process or data restrictions such as the quarantine process outlined above.

### BRIEF DESCRIPTION OF THE DRAWINGS

FIG. 1 illustrates a method for creating an asset record container (ARC) in accordance with the invention.

FIG. 2 illustrates a secure access to the owner of the asset record container (ARC) in accordance with the invention.

FIG. 3 illustrates the assignment of permissions through the session identification mechanism in accordance with the invention.

FIG. 4 illustrates the vendors and practitioners accessing the information through the session identification mechanism in accordance with the invention.

FIG. 5 illustrates information and contact information that is captured in a deposit record in accordance with the invention.

FIG. 6 illustrates information and contact information that is withdrawn to create a withdrawal record in accordance with the invention.

FIG. 7 illustrates the container being populated with information by various entities in accordance with the invention.

FIG. 8 illustrates an example of formats the information can be accepted by the asset record container in accordance with the invention.

FIG. 9 illustrates a process of examining and certifying information prior to deposit into the asset record container (ARC) in accordance with the invention.

FIG. 10 illustrates an example of a payment mechanism to the certifying practitioner in accordance with the invention.

FIG. 11 illustrates a payment method for digital application production and implementation in accordance with the invention.

FIG. 12 illustrates a process by which information is standardized and converted into other standards in accordance with the invention.

FIG. 13 illustrates a process by which information is converted from global standards into the Asset Record Container (ARC) universal key element standard in accordance with the invention.

FIG. 14 illustrates a process by which the Asset Record Container allows communications and maintains a deposit record of communications with other entities in accordance with the invention.

FIG. 15 illustrates an ability of owners to publish information in accordance with the invention.

FIG. 16 illustrates a transaction and inspection mechanism in accordance with the invention.

FIG. 17 illustrates an Asset Record Container (ARC) seller retaining a historic copy of the ARC after the sale in accordance with the invention.

FIG. 18 illustrates a preferred embodiment of the Asset Record Container (ARC) in accordance with the invention.

### DETAILED DESCRIPTION OF THE DRAWINGS

The invention is a method that creates real estate information 700 ownership, control, integrity and transfer. In the detailed description as set forth below, we refer to the preferred embodiment of the present invention as the Asset Record Container™ 200 or ARC 200.

Other useful information 700 and contact management systems have been created in the real estate industry. The present invention interacts with these existing systems and offers real property Owners 300 a permanent method for information 700 asset Ownership as personal property (chattel).

The present invention includes a digital container 200 to hold and convey subject property information 710 and its human sources 720.

At inception, each ARC 200 is assigned a unique identification number 400 by the Administrator 10. This Unique ID 400 system provides a mechanism for ARC legal Ownership 215. The subject Real Property Ownership 215 is confirmed by a Certified Practitioner. Certified Practitioners 550 include, but are not limited to: Realtors® 560, Appraisers 555, Architects 570, Engineers 575, Surveyors 565 and Accountants 580. Certifying Practitioners 550 are licensed in their respective fields and members of a trade organizations with a mandatory code of ethics ensuring honesty and integrity. This method of ownership gives full control over the ARC and accommodates future sale or use as collateral.

Each container 200 is loaded with subject property specific information 710 by Owners 300, Practitioners 550 and Vendors 600. This information 700 becomes a part of the ARC 200 Hypertext through the invention's transclusion process.

Relevant information 700 and relationships 720 are deposited 240 by Owners 300, Vendors 600 and Practitioners 550 on behalf of the Owner 300. Information 700, video 776, audio, photographs 762 and detailed analysis regarding the subject property are accepted inputs using a multitude of formats. The Owner 300 controls access and permissions 235 through a virtual web portal manager 270 embedded into the ARC 200. Usefulness and relevance are continuously enhanced by integrating 285 relevant application 1000 tools 1030, analytics 1020 and gadgets 1050 produced by outside Application Entrepreneurs 1100. Owners' 300 access and pay 305 for these applications 1000 through a digital marketplace 1005 hosted by the company administrator 10. Payment 305 to Application Entrepreneurs 1100 occurs when Owners 300 purchase their applications 1000. Existing software and management systems accept inputs and generate outputs to the ARC 200 using accepted real estate standards 800. The present invention includes a Deposit Record 25 and Withdrawal Record 30 that maintain a Historic Record 290 of interaction with the information 700 and relationships 720 contained within the ARC 200. This history is accessible for the Owner 300 or through Owner assigned permissions 235. The ARC also features a mechanism which translates 900 each accepted real estate standard 800 to other competing standards 800. The ARC 200 allows for a reconciliation 930 of conflicting information 700 points. This reconciliation 930 is accomplished by applying hierarchies 940. Within the ARC 200 communication 270 is accommodated between Practitioners 550, Owners 300 and Vendors 600. Inputs are time stamped and capture the information 700 source, maintained in the Historic Record 290. This History Record 290 provides information 700 accountability throughout the ARC 200 life cycle. Compensation 1210 for Practitioners 550 who certify information 710 accuracy is accommodated by the administrator 10. Owners 300 can publish 260 information 700 publicly using a custom MicroSite 225.

ARC 200 Ownership 215 sale 1390 are accommodated through the Administrator 10. This process includes a Buyer 1350 inspection period 1320 where the Seller 1340 delivers the ARC 200 to quarantine 1310 along with the terms of its release 1330. The Buyer 1350 has rights of refusal 1360 and is ultimately responsible for fulfilling the terms of release 1330. Once both parties are satisfied, title 215 to the ARC 200 is transferred 1330 by the administrator 10 and the buyer 1350 immediately becomes the new Owner 300 with all rights 310 of Ownership 215.

This invention does not include a sale mechanism for the underlying real property 100, only the ARC 200 Ownership 215 is transferred.

After such a transaction the Seller 1340 (prior Owner 300) has the right 310 to keep a ‘historic copy’ 1410 as part of the ARC 200 sale 1390. The ‘copy’ 1410 serves only the prior Owner 300.

The Administrator 10 confirms that the Certifying Practitioners 550 are licensed in their respective fields and members of a trade organizations with a mandatory code of ethics ensuring honesty and integrity. Certified Practitioners 550 enter and maintain information 700 pertinent to the real property 100. The Owner 300 of each ARC 200 pays 305 an annual administration fee which is partially distributed to the Certified Practitioner 550 for maintaining certifying correct information 710 in the ARC 200.

Vendors 600 linked to the present invention include, but are not limited to: Banks and other Lenders 630, Asset Managers 670, Facilities Managers 660, Property Insurance Companies 650, Title Insurers 640, Attorneys 610, Government 620, Valet Service Providers 690 and Other Vendors 680. These Vendors 600 will see value in the present invention by establishing an efficient means for communication 270 and information 700 transfer.

In the preferred embodiment of the present invention, fee Owners 300 of real property 100 create Asset Record Containers™ 200 (ARC™ 200). The ARC 200 creates proper control of information 700 and human relationships 720 vital to a real property's 100 long term value and marketability.

Traditionally Owners 300, Practitioners 550 and Vendors 600 all keep separate informal 700 records 290 and files for each subject property 100. Having multiple organizations and individuals keep highly similar information 700 is inefficient and generates scattered inconsistent information 700 about a single subject property 100. The present invention provides the preferred Owner 300 controlled location for subject property 100 related information 710 and relationships 720.

The ARC 200 is established through registration where the Owner 300 connects with the company Administrator 10 using a web enabled device 1450. A container 200 is conveyed to the Owner 300 for recording 290 critical property centric information 710 and human relationships 720 who certify the accuracy and completeness of the information 700. This conveyance begins with the Owner 300 identifying the subject property's 100 salient facts; including the Country, State and postal address 120 of the real property 100 asset to be the subject of the Asset Record Container 200. The Owner 300 must also convey contact information 720 as it relates to the Asset Record Container 200, including: Owner 200 name and preferred electronic mail address 315. A Service Agreement 47 is then required. This Service Agreement 47 calls out the details of the relationship between Owner 300 and company acting as Administrator 10 of the ARC 200. The Owner 300 may also enlist a Vendor 600 or Practitioner 550 familiar with the subject property 100 to assist in completing the specific inputs, analysis and uploading of known human relationships 720 interacting with the subject property 100.

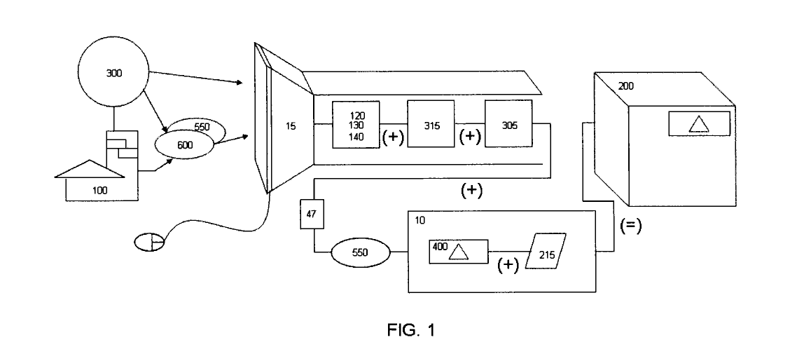

With reference to FIG. 1, Gateway Figure represents the method of creation for an ARC 200. The Owner 300 having interest in a Real Property 100 either 1.) directly interacts with the interface of the Administrator's Computer Server 15 as a creator, or 2.) authorizes a Certified Practitioner 550 or Vendor 600 to create the ARC 200 by interacting with the interface of the Administrator's Computer Server 15. When prompted, the creator provides one of the subject property's 100 identifying features which include but are not limited by: Postal address 120 County Identifying Number 130 or Latitude and Longitude coordinates 140. Next the system prompts the creator for Owner 300 Characteristics 315. The system then prompts creator for the Owner 300 preferred method of payment 305. A Service Agreement 47 acceptance is required to generate a ‘get request’ for a Certified Practitioner to confirm (as a third party) the subject property's ownership. The assignment of a permanent Unique Identification Number 400 and Ownership Title 215, completes the creation of an ARC 200. This Unique Identification Number 400 is a permanent part of the ARC 200.

The ARC 200 is permanently identified by the Unique Identification Number 400 and linked with the subject property 100 it pertains to.

The Unique ID 400 is veiled with a pre-determined algorithm relating it back to the core file structure and is comprised of two elements:

In a preferred embodiment, the Unique ID 400 is comprised of two elements: The first being a proprietary seven (7) digit ARC 200 ID 400 system which is a unique combination of numbers and letters. The second is based on the ISO standard for country, state or province and county identification. This ID 400 system when presented will enable the ARC 200 Owner 300, and other stakeholders to identify characteristics of the subject property 100 linked to the ARC 200. It should be understood among those skilled in the art that a wide range of numbering systems may be utilized while remaining within the scope of the invention.

The International Organization for Standardization (ISO) has established numbering systems by which countries are identified (ISO 3166-1) as well as dependent territories and special areas of geographical interest (ISO 3166-2 (“ISO 3166-1 alpha-2”)). These ISO Standards are incorporated in ARC's Unique ID.

This unique ID 400 system provides the Owner 300 of the subject property 100 with a method of legal Ownership 215. This legal Ownership 215 is enforced and published by the administrator 10. The Owner 300 of record has full rights 310 of continuous access 320 and the ability to sell or collateralize the ARC 200.

As an example: a bank 630 lending on the subject property 100 may request the Owner 300 to include their ARC 200 as collateral in a promissory note or as part of the mortgage agreement. This will ensure the bank 630 has all of a property's 100 pertinent information 710 and relationships 720 in the event of a foreclosure. It is much easier for the bank 630 to maintain and liquidate a property 100 with an accompanying ARC 200.

Each ARC 200 is accessed by the Owner 300, through a secured web portal with a user interface.

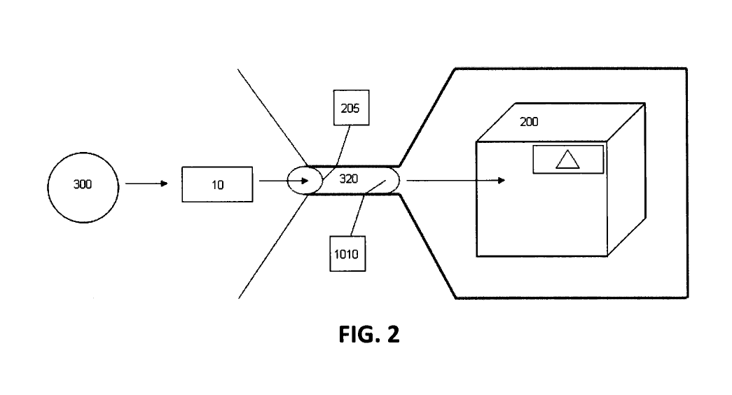

With reference to FIG. 2, each ARC™ 200 includes a secure system of commands 205 and third party security applications 1010 providing the Owner 300 access to their specific Asset Record Container 200. The Administrator 10 maintains the web portal 320 through the secure interface.

Owners 300 have the option to select security applications 1010 they are most comfortable with through the digital marketplace 1005. Security applications 1010 can include: a user name and password, open id, biometric id or other custom solutions available.

Owner 300 controls Access Mechanisms 230 and permissions 235 through a virtual manager 270.

The virtual manager 270 interacts with interested parties attempting to access the container 200. The virtual manager 270 is controlled by the Owner 300. This mechanism allows for timed access using a Session ID 450 method.

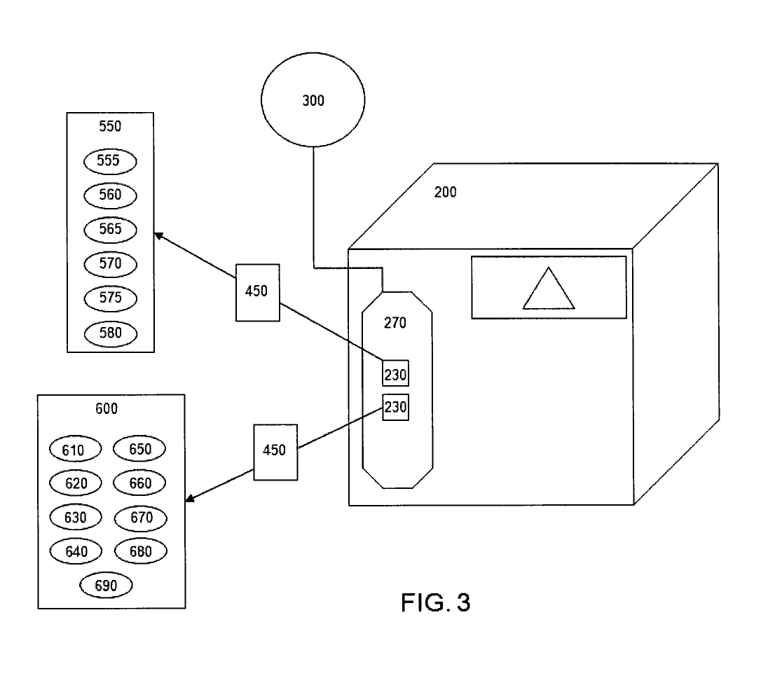

With reference to FIG. 3, the Owner 300 controlling access using the virtual manager 270 which generates Session ID 450 for Certified Practitioners 550 (Appraiser 555, Realtor® 560, Surveyor 565, Architect 570, Engineer 575 and Accountant 580) and Vendors 600 (Legal 610, Government 620, Lender/Bank 630, Title 640, Insurance 650, Facilities Management 660, Asset Management 670, Other Vendors 680 and Valet Services 690). This access is granted for all or parts of the ARC 200.

The access URL hyperlink is delivered by electronic communication to the interested parties.

Components of information 700 are often shared with multiple Practitioners 550 and Vendors 600. Examples; A bank 630 may have interest in getting salient information 710 from an appraiser 555. An Appraiser 555 might have interest in getting leasing information 710 from a Realtor® 560. A Realtor® 560 may have interest in getting survey information 710 from a Surveyor 565.

The Practitioners 550, Vendors 600 and stakeholders that serve a property 100 have information 700 to share and require information 700 in order to provide service to the Owner 300. The Owner 300 permits deposits 240 of information 700 along withdrawal 250 (sharing) through the Access Mechanism 230 of the ARC's 200 virtual manager 270.

The Access Mechanism 230 operates using an individual Session ID 450 method allowing permissions 235 which include timeframes, component access levels and the distribution levels. The Owner 300 activates all Session IDs 450. The secure Session ID 450 in the ARC 200 virtual environment is used by a specific individual, for a specific purpose and for a limited time. The Session ID 450 method contains the Access Mechanism 230 credentials housed within a single URL.

Each ARC 200 includes permissions 235 assigned within the Session ID 450 method.

The ARC 200 system segregates 220 information 700 into individual component pieces and allows the Owner 300 to easily and securely choose who can access what information 700 and for how long.

Example, a Realtor 560 requests certain pieces of information 700 that were provided by the Surveyor 565 and the Appraiser 555, the Owner 300 grants a Session ID 450 for such requested information 700 through the virtual manager 270. This system allows Owners 300 to limit access to other information 700 such as tax returns and lease details which are confidential.

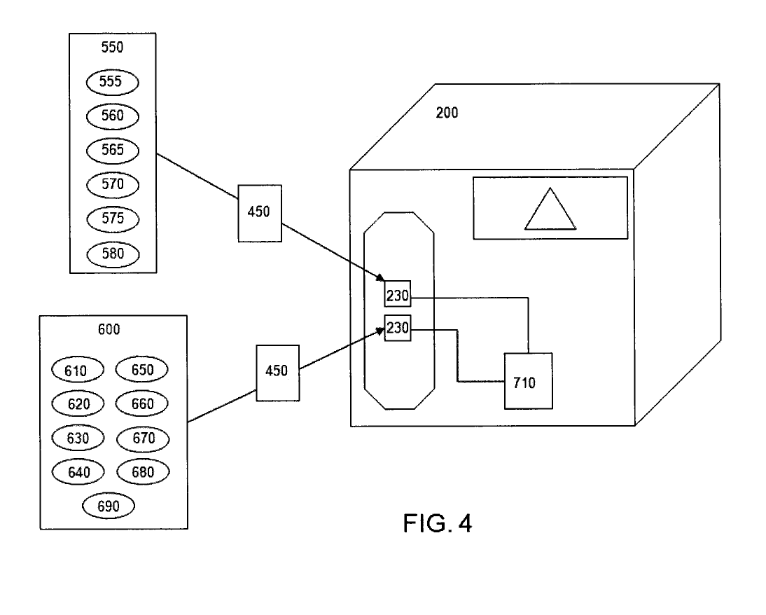

With reference to FIG. 4, Certified Practitioners 550 (Appraiser 555, Realtor® 560, Surveyor 565, Architect 570, Engineer 575 and Accountant 580) and Vendors 600 (Legal 610, Government 620, Lender/Bank 630, Title 640, Insurance 650, Facilities Management 660, Asset Management 670, Other Vendors 680 and Valet Services 690) using a Session ID 450 to interact with Property Information 710 through the Access Mechanism 230 within the ARC 200.

A detailed Historic Record 290 of access is created and maintained for each Session ID 450 by the ARC 200 virtual manager 270. Each access record 290 is available for the Owner's 300 examination.

A detailed record 290 of information 700 and relationships 720 deposited 240 or withdrawn 250 is created and maintained by the ARC 200 virtual manager 270.

The historic Deposit Record 25 ensures that each point of unique property information 710 is associated to its human source 720. In this preferred embodiment of the detailed record 290, information 700 accountability is maintained.

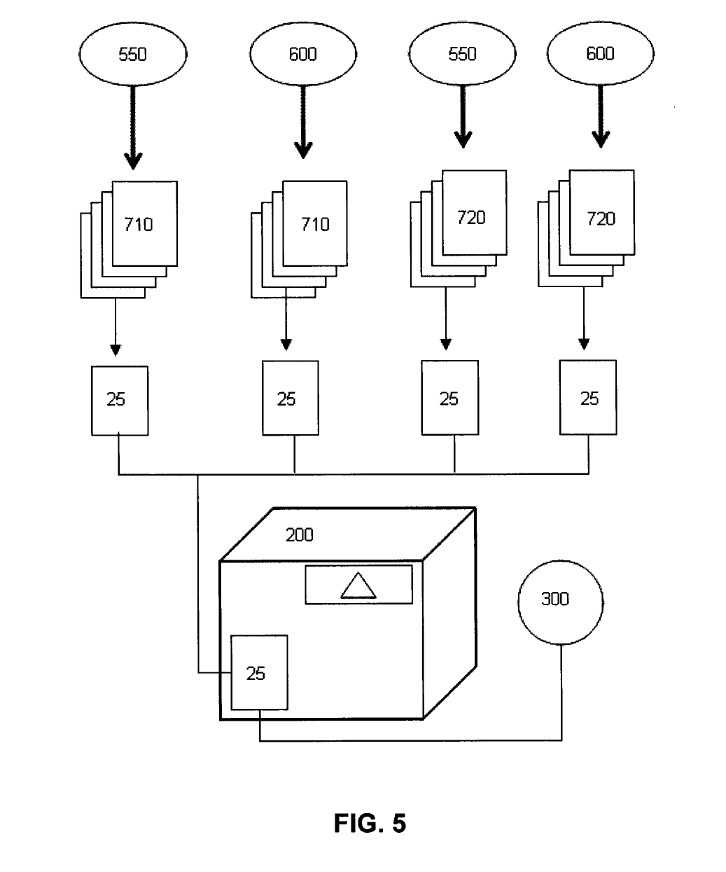

With reference to FIG. 5, Property Information 710 and contact information 720 is input (deposited) by Certified Practitioners 550 and Vendors 600 into the ARC 200.

The information specific Deposit Record 25 is captured at the time information is input. The captured information is permanently recorded 290 into the ARC 200 for Owner 300 access, review and analysis.

The Deposit Record 25 is used by the Owners 300 when there is a dispute surrounding information 700 accuracy. Using the ARC 200 Deposit Record 25, Owners 300 maintain the ability to find out when and by whom the information 700 was input 240. This minimizes Owner 300 liability and creates Practitioner 550 and Vendor 600 accountability.

The Invention also includes a Withdrawal Record 30 used by the Owners 300 who maintain the ability to find out when and by whom the information 700 was withdrawn 250.

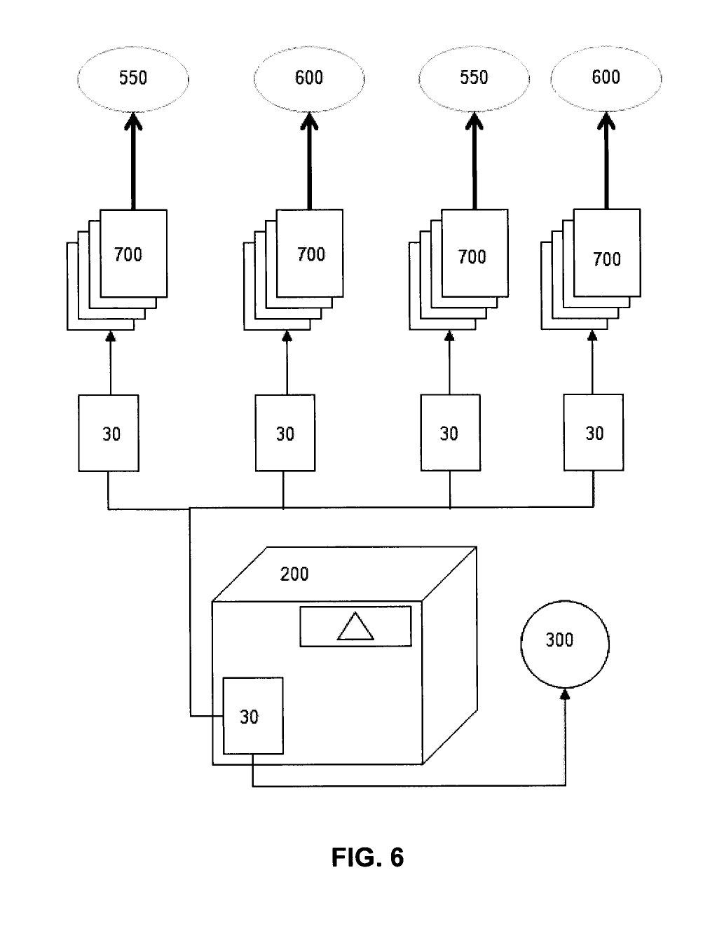

FIG. 6 shows Information 700 withdrawn 250 by Certified Practitioners 550 and Vendors 600 from the ARC 200. A Withdrawal Record 30 is maintained within the ARC 200 for Owner 300 access.

“Withdrawn” 250 includes, but is not limited to: copied, printed, viewed, exported or other means of capturing information 700 contained within the ARC 200.

The Withdrawal History 30 captures who has withdrawn 250 information 700 and what was withdrawn 250. This feature provides Owners 300 with the ability to track interactions inside of their ARC 200.

Each container 200 is populated with relevant property information 710 and relationships 720 by Owners 300, Certified Practitioners 550 and property Vendors 600. The invention is designed to be a permanent and Historical Record 290 of relevant subject property 100 specific information 710, documents and human relationships 720.

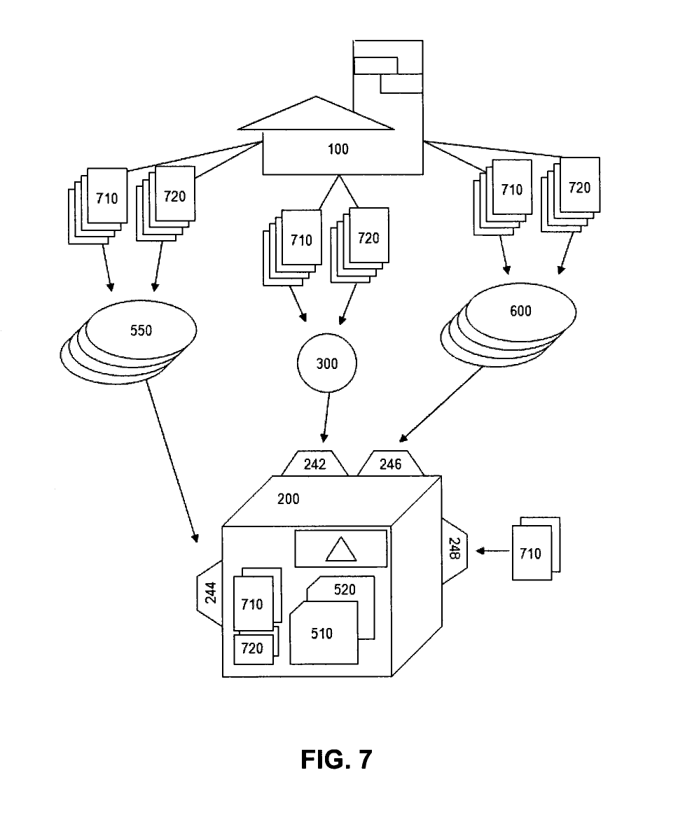

FIG. 7 is a representation of how an ARC is populated through the Keyed/Voice Recognition static field entry mechanisms 242, 244, 246 and through automatic, manual or dynamic migration 248. Real Property 100 will include Residential Real Estate and Commercial Real Estate. Residential Real Estate includes single family homes, multi-family 1-4 units, condominiums, townhouses and platted but undeveloped land. Commercial Real Estate includes office, industrial, retail, special purpose, commercially zoned development land, 5+ unit large multi-family and any other location where business (private) or public activities are achieved.

Owners 300 deposit 240 information 700 through the Deposit Mechanism 242, Certified Practitioners 550 deposit 240 information 700 through a separate Deposit Mechanism 244, Vendors 600 also deposit 240 information 700 through a separate deposit mechanism 246 and information 700 from external portals is received through feeds of relevant property information 710 into the ARC 200. The ARC 200 accepts Practitioner certified information 510, Vendor certified information 520, property information 710 and relationship information 720.

Multiple file formats are adapted to be viewed by Practitioners 550 or Vendors 600 with different levels of technological sophistication. Examples include video 776, audio, text 764 and pdf 770.

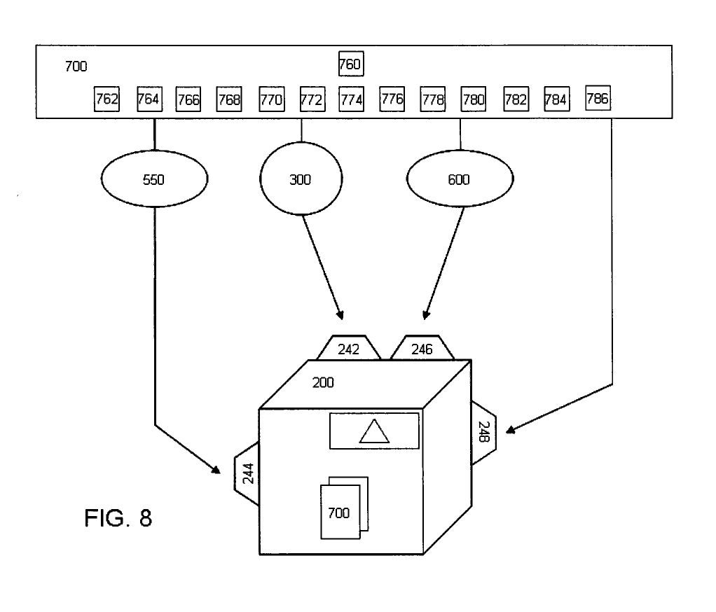

FIG. 8 is a representation of accepted formats within the ARC 200 for property information 710 and contact information 720. Information formats include but are not limited to Raster and Vector Graphic formats—*.jp, .gif, .png, .tif, .bmp 762; Text Based formats—*.xl, *.do, .txt, .rtf , .wks, .wps, .odt, .csv 764; Unicode Web Based format—*.xm 766; Graphical Document formats—*.pp, .pub, 768; Portable Document format—.pdf 770; Accounting formats—*.qb, qsd, *.pt, *.nm 772; Database formats—*.db, .mdb, .accdb, *.fp 774; Video/Audio formats—*.mp, *.wm, .swf, .flv, .mov, .wav, asf, avi 776;

Computer Aided Design formats—.cad, .dxf, .dwg 778; Compressed format—.zip 780; E-mail Messaging formats—.msg, .vcf, .mht, .eml 782; Geospatial Mapping format—.shp 784; Other formats—other file formats 786.

Formats which are generally accepted in the market place ensure interaction with all levels of technological sophistication.

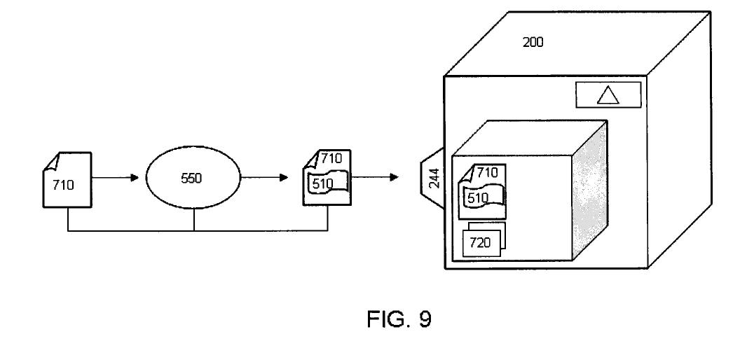

FIG. 9 shows Property Information 710 which is collected by a Certified Practitioner 550. The Certified Practitioner examines the Property Information 710 and Certifies 510 its accuracy. Once certified, information is deposited 244 into the ARC 200. The ARC now contains Certified 510 Property Information 710, with its related Contact Information 720.

Information 700 in any form is suspect until formally confirmed by an expert in the field of its origin. The present invention accommodates this confirmation of information 700 through a certification process. This critical element is designed to provide Owners 300 and all other interested parties with multiple layers of confirmed “Certified” information 510 regarding a subject property 100. ARC 200 Certified Information 510 refers to information 710 that an approved Certified Practitioner 550 has confirmed to be accurate and deposited into the ARC 200.

Best practices within the real estate industry typically include engaging Practitioners 550 with specific skills, licenses and affiliations necessary to complete research, analysis and provide other services pertaining to a real property 100. These Practitioners 550 often include but are not limited to Appraisers 555, Realtors® 560, Architects 570, Engineers 575, Surveyors 565 and Accountants 580. There are also Vendors 600 such as Attorneys 610, Lenders 630, Title Companies 640, Property Insurers 650 and Management Companies 670 which provide services and information 710 pertaining to real property 100. The present invention distinguishes between Practitioners 550 and Vendors 600.

Qualified Practitioners 550 who certify information 710 are referred to within the present invention as “Certified Practitioners” 550. These Certified Practitioners 550 are required by the ARC 200 administrator to be licensed and be a member of a preferred trade organization with a code of ethics prohibiting falsification of information 700. Examples of these trade organizations include but are not limited to the Appraisal Institute, National Association of Realtors, National Society of Professional Surveyors, American Institute of Architects, National Society of Professional Engineers and the American Institute of Certified Public Accountants. The ARC 200 administrator 10 maintains an active list of all Certified Practitioners 550 who qualify to certify information 710. Certificated Practitioners 550 must adhere to the administrator's 10 code of ethics.

Each individual piece of information 700 entered into the present invention by a Certified Practitioner 500 is permanently recorded 290 in the ARC 200 Deposit Record 25. This Deposit History 25 holds the Certified Practitioner 200 accountable for all information 700 entered into the ARC 200 and provides the Owner 300 with the ability to track who entered the information 700.

The invention contains a payment 1210 scheme to compensate accepted Certified Practitioners 550 who have deposited information 700.

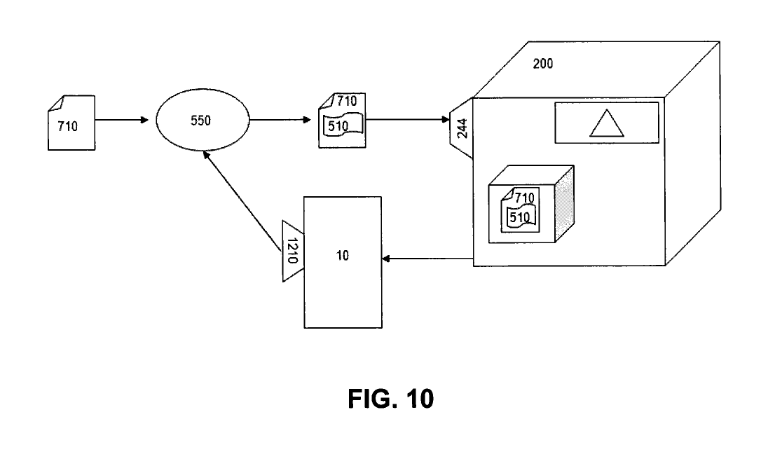

FIG. 10 shows Property Information 710 being confirmed and Certified 510 by the Certified Practitioner 550. The Certified Information is then input 244 to the ARC 200. Payment 1210 to the Certified Practitioner 550 is accommodated by the Administrator 10.

The Invention makes payments 1210 to the Certified Practitioners for property information 710 accountability.

The Accuracy of deposited 240 property information 710 can be confirmed by others through contacting the Certified Practitioner who is compensated through the Payments 1210 by the Administrator 10.

Administrator 10 receives Owner payments 305 as a subscription fee. This fee is used in part to compensate the Certified Practitioners for maintaining accurate information within the ARC.

The Administrator 10 makes payments 1210 the Certified Practitioners 550 based on a defined percentage allocation within the contract 45.

Vendors 600 work exclusively for Owners 300 of real property 100. Vendors 600 are not required to hold State Licensure or be a member of a trade organization with a code of ethics. Vendors 600 can access the ARC 300 with a proper Session ID 450 (assigned permissions 235) provided by the Owner 300. Vendors 600 have the ability to add (deposit) uncertified information 700 or withdraw 250 information 700 based on Owner 300 assigned permissions 235.

Digital Application Entrepreneurs 1100 provide ARC 300 Owners 200 with tools 1030, analytics 1020 and gadgets 1050 through a digital marketplace 1005.

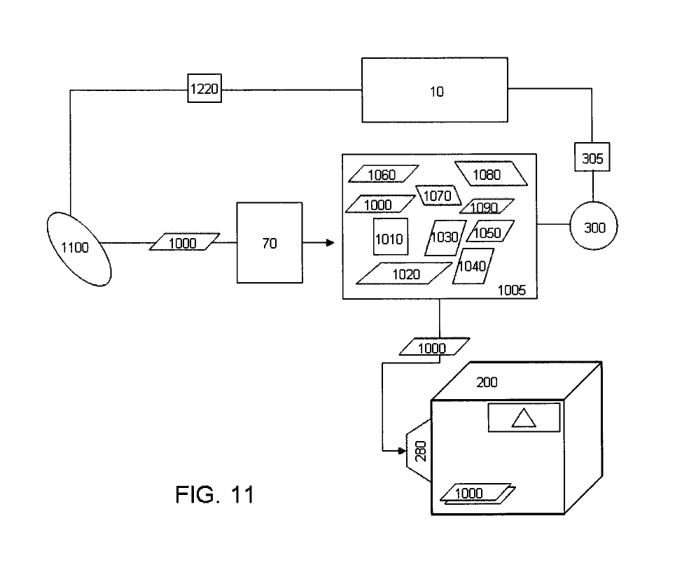

FIG. 11 shows Digital Application Entrepreneurs 1100 build Custom Applications 1000 including but not limited to Security 1010, Analysis 1020, Tools 1030, ARC Interface 1040, Gadgets 1050, Facility Management 1060, Financial Management 1070, Property Marketing Tools 1080 and Other Applications 1090. These Applications 1000 go through an Application Approval Process 70 prior to being published in the Application Store 1005 which is maintained by the Administrator 10.

ARC Owners 300 make Payments 305 for Applications 1000. The Administrator 10 directly compensates 1220 the Application Entrepreneurs 1100.

Once an application 1000 has been acquired, the Owner 300 integrates the applications 280 into the ARC 200.

This compensation 1220 happens through multiple payment schemes including but not limited to: Onetime payment for acquisition, subscription payment, use payment and others. The payment scheme is determined by the Application Entrepreneur 1100 and approved by the Administrator 10.

Application Entrepreneurs 1100 include but are not limited to: software companies, developers, designers, other platform Application Entrepreneurs, real estate companies and other interested parties.

Layered within the ARC 200, there is an open source interface (API) for the development of applications 1000 by Application Entrepreneurs 1100 and established real estate technology companies 1130. To ensure a robust application market place 1005 for ARC 200 Owners 300, the Administrator 10 provides a compensation model 1200 that encourages digital Application Entrepreneurs 1100 to construct relevant tools 1030, analytics 1020 and gadgets 1050.

Through the invention's API, both new and established technologies can interact with the ARC 200 on behalf of the Owner 300.

Examples of established technology companies 1130 include: Argus® is a financial analysis tool used by the commercial real estate industry providing asset valuation, forecasting, operations, and cash flow models; Yardi® is tailored to facilities and asset managers 670 who run the day-to-day operations of an income producing property 100; CoStar® is a research company with a comprehensive database on commercial real estate; MLS or the “Multiple Listing System” is a platform popular in the residential real estate market.

Keyed information 710 is entered into fields based on the ARC Universal Standard 850 schema. The invention also includes a mechanism that normalizes 950 information 700 imported from one of the accepted real estate standards 800. The ARC 200 converts 925 the information 700 to another schema which can be exported to systems using other real estate standards 800.

The existing supported Standards 800 have been developed by: the Mortgage Industry Standards Maintenance Organization (MISMO) 820, Real Estate Standards Organization who has put forth the Real Estate Transaction Standard (RETS) 810, the Open Standards Consortium for Real Estate (OSCRE) 830 and the Property Records Industry Association (PRIA) 840. Each of these standards 800 is further described below.

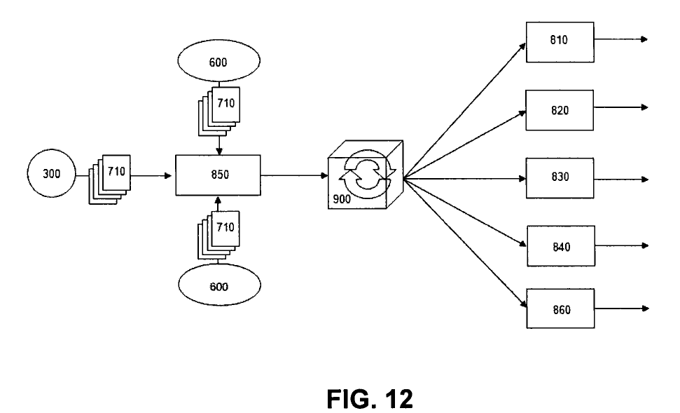

FIG. 12 shows the process where Certified Practitioners 550, Vendors 600 and Owners 300 input property information 710 using the ARC Universal Standard 850. This information is then pushed to the Standards Converter 900 which converts 925 the information into one of the other standards RETS 810, MISMO 820, OSCRE 830, PRIA 840, or other standards 860 for use by the global market.

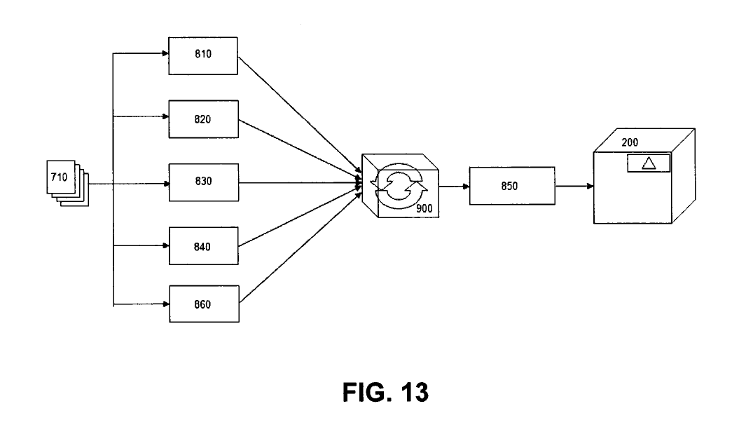

FIG. 13 shows property Information 710 captured from RETS 810, MISMO 820, OSCRE 830, PRIA 840 or Others 860 in their native schema is input into the ARC Standards Converter 900 which normalizes 950 the information into the ARC Universal Standard 850 for deposit 240 into the ARC 200.

The Real Estate Transaction Standard (RETS) 810 is a data standard that is used by multiple MLS services. RETS 810 provides a open source Vendor neutral, secure approach to exchanging listing information 710 between the broker 565 and the MLS and allows for seamless information 700 transfer between MLS's and national aggregators of that same information set (i.e. Homes.com, Realtor.com).

Through the present invention, RETS 810 allows Owners to efficiently interact with Realtors® 565. This efficiency for Realtors® 565 will be realized through the ARCs 200 ability to communicate directly with the listing tools 1030 mentioned above, eliminating the need for redundant information 700 entry.

The Mortgage Industry Standards Maintenance Organization (MISMO) 820 is the standard 800 of the Mortgage Bankers Association. The standard 800 supports many important 700 functions of real property 100 transfers including mortgage underwriting, appraisal 555, credit reporting, insurance, loan servicing, and secondary mortgage market investor reporting. Mortgage lenders 610, investors in real estate 100 and mortgages, servicers, industry Vendors 600, borrowers and other parties exchange real estate finance-related information 700 using this standard 800. ARC 200 supports, normalizes 950 and converts 925 MISMO 820 standard XML schema to other standard 800 schema integrated into the invention.

MISMO 820 standardized information 700 from the ARC 200 can transfer directly into a mortgage banker's forms. The transfer saves the mortgage banker time and it decreases the risk of incorrect entry. The same standard 800 information 700 located in the ARC 200 can be reused to quickly accommodate a later loan application by an existing or future property Owner 300.

The Open Standards Consortium for Real Estate (OSCRE) 830 is a global standards organization that publishes standard schema focused on global information 700 exchange including: appraisal reporting, lease abstracts, work requests, commercial information exchange, commercial introductions, E-registration, home information packs, investment valuation, lease delivery, lenders conveyance, occupancy cost, portfolio information exchange, residential conveyancing, searches standard, work request and work order fulfillment, and PISCES standards. OSCRE Standards 830 are applicable in the United States and Europe. OSCRE 830 is a set of open source XML schemas that are a contextualized set of definitions and rules that facilitate the automatic transfer of information 700 between independent information 700 systems. ARC 200 supports, normalizes 950 and converts 925 OSCRE 830 standard XML schemas to other standard schema integrated into the invention.

Property Records Industry Association (PRIA) 840 is the standard used by businesses and government members of the property records industry, with the end goal of facilitating E-recordation 290 of and simplified access to public property records.

The invention accepts information in PRIA 840 standard schema and also converts 925 and outputs other standard scheme using the PRIA 840 standard schema. The Administrator 10 uses this standard 840 to allow Vendors 600 and Practitioners 550 to verify with the appropriate government 620 entity Ownership and public records for the real property 100.

Each existing standard organization 800 has its own interests, management, funding and unique historical position. These factors create tension and conflicting proprietary agendas within the standards discussed here. Additionally certain gaps in the standardization process exist. The ARC 200 mechanism fills the gap by normalizing 950 and converting 925 information 700 on behalf of the Owner 200 and their stakeholders. The ARC Universal Standard 850 is the normalizing 950 standard that enables one standard 800 to be converted 925 to others.

There are common characteristics within each standard 800 which are captured in the ARC Universal standard 850. This allows for a radical reduction in redundant information 700 entry, human errors and an immediate increase in information 700 transparency required

We envision that other future standards 860 will interact with the ARC 200 in a similar way as the existing standards 800 outlined herein.

The ARC 200 offers a medium by which stakeholders can reconcile 930 conflicting information 700 points creating information confidence and further transparency to lenders 630 and inquisitors.

The standards converter 900 shown in FIGS. 12 and 13 accepts information 700 and normalizes 950 it into the ARC Universal Standard 850. If conflicting information 700 exists in the ARC Universal Standard 850, an information 700 conflict red flag 920 is prompted. The administrator 10 notifies the Owner 200, Certified Practitioner 550, Vendor 600 or other affected parties of the conflict. The administrator 10 also includes a standard information 700 source hierarchy 940 in the notification.

The hierarchy 940 is based on Practitioner 550 expertise. An example would be if a Realtor® 560 entered a property's 100 land size which was found in the public record and then a State Licensed Surveyor 565 who completed a survey entered a different number based on actual field work. In this case the hierarchy 940 would suggest that the Surveyors 565 number be used and certified as accurate by the administrator 10.

The communication 270 between the administrator 10 and the Owner 200, Certified Practitioners 550, Vendors 600 or other affected parties is accommodated through Owner 200 assigned Session IDs 450.

This method of Session IDs 450 enable the ARC 200 to function as a virtual meeting place for matters concerning the subject property's 100 information 710. Within the ARC 200, interaction is accommodated between humans or directly with the ARC 200.

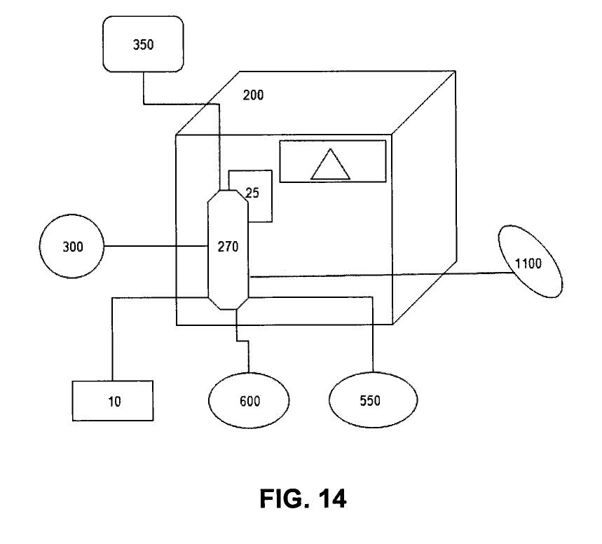

FIG. 14 shows the virtual manager 270 with a Deposit Record 25 positioned within the ARC 200 facilitating electronic communications between the Owner 300, Administrator 10, Tenants 350, Certified Practitioners 550, Vendors 600 and Application Entrepreneurs 1100.

The invention includes a secure interface with direct communication 270 portals for Owners 200, Vendors 600, Certified Practitioners 550 and interested stakeholders to interact with the each other or directly with the ARC 200. Communications happen several ways including but not limited to: notes attached to information 700 deposits, instant messaging, In-mail, video chat, blogs, and an email system. Preferred communication methods are activated by the Owner 200. Over time new communication methods can be accommodated by the Application Entrepreneurs 1100 filling unique needs for Owners 200.

The virtual manager 270 has a mechanism to forward communication to other preferred electronic devices like Blackberry®, iPhone®, Palm® and Droid®, or e-mail systems such as Gmail® MSN®, AOL®, Yahoo! Mail®. These communication mechanisms are supported by the ARC 200.

The invention includes a method for all communications which takes place through the virtual manager 270 to become part of the Deposit Record 25. Communications within the ARC 200 can be organized 220, recorded 290 and searched 295.

Owners 300, publish 260 components of an ARC 200 publicly or to private entities including but not limited to prospective tenants 350, buyers 1350, lending institutions 630 or insurers 650. This is accomplished through an ARC 200 MicroSite 225, other Vendor 600, Certified Practitioner 550 web sites or computer networks the Owner 200 chooses.

A MicroSite 225 can be created once the ARC is in place. The Owner uses a simple click and drag method to insert information into his MicroSite 225. If the Owner 300 has an existing website for a property 100, the ARC MicroSite 225 will actively link to allow the existing website to use the ARC publisher 260.

The publisher 260 can be programmed by the Owner 300 to customize the MicroSite in additional ways. If an Owner 300 has several properties 100 with an ARC 200 for each one, the Owner 300 has the ability, using the virtual manager 270 to integrate several properties 100 to a single MicroSite 225 for publishing 260. Publisher 260 outputs include but are not limited to public 262, tenants 264, buyers 266 or other output viewers 268.

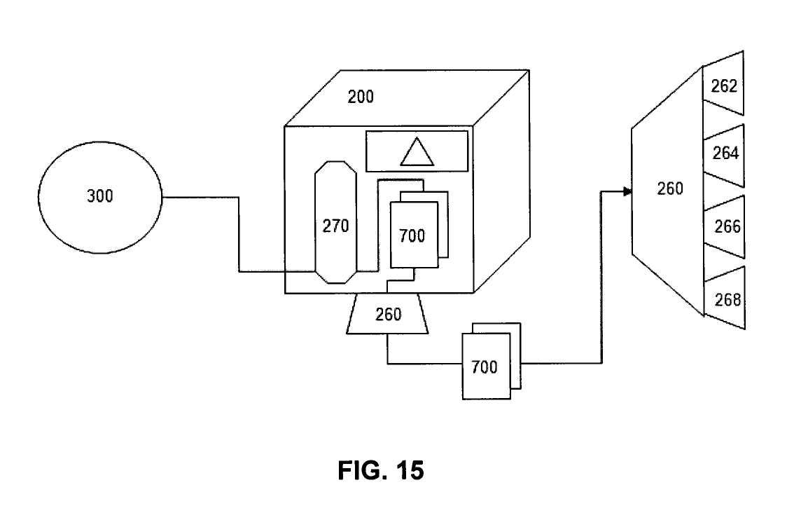

FIG. 15 is a schematic representation of how the Owner 300 publishes 260 components of their ARC 200. Owners 300 identify Information 700 sent to a publisher 260 through their Virtual Manager 270. The Owner controls which information, how long and to whom it is published. Publish viewers include, but are not limited to: general public view 262, an existing or prospective tenant view 264, or prospective buyer view 266.

Owners 300 ability to publish 260 information 700 allows them to convey information 700 to larger groups with greater efficiency.

An example of the publish mechanism 260 is: an Owner 300 wants to inform Tenants 350 that the Subject Property 100 will be under renovation and that building 100 traffic flow will be affected. The Owner 300 can publish 260 building 100 elevations, traffic flow and architectural design drawings.

Another example is an Owner 300 marketing the subject property 100 for sale using a Realtor® 560, the Realtor® 560 points prospects to the MicroSite 225 to view published 260 details on the property 100.

The Owner 300 has the ability to sell 1390 the entire ARC 200.

When a subject property 100 is sold the ARC 200 is also typically sold 1390. At the sale, 1390 of the ARC 200 the seller gives permission 235 through the virtual manager 270 for the ARC 200 to be placed in quarantine 1310 for a buyer 1350 inspection period 1320.

During the inspection period 1320 the Seller 1340 puts forth the terms of transfer 1330 to the Administrator 10, the buyer 1350 has full access to review the ARC 200. One the buyer 1350 has fulfilled the terms of transfer, the Administrator releases the ARC 200 from quarantine 1310 and the buyer 1350 become the new owner 300 with all rights of ownership 310 and control 330 of the ARC 200.

The new owner 300 has the immediate ability to input 242 property information 710 or contact information 720 surrounding the property. As an example: new information would typically include all Title Company 640 information 700 and lender 630 agreements generated for the new owner 300. The seller 1340 has the right to retain an ARC copy 1410.

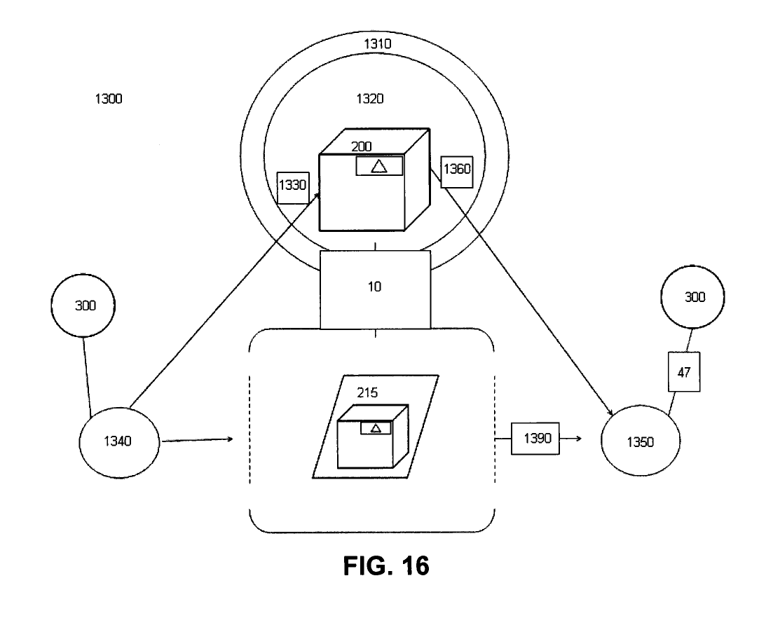

FIG. 16 shows how the Administrator 10 provides a transaction mechanism 1300 for buyers 1350 to buy and sellers 1340 to sell an ARC 200 and transfer the ARC 200 title 215. During the inspection period 1320 the ARC 200 is placed in quarantine 1310 after seller 1340 puts forth the terms of transfer 1330 to the Administrator 10. The buyer 1350 has full access to review the ARC 200 with rights of refusal 1360, to complete the sale 1390, the buyer 1350 is responsible for fulfilling sellers 1340 terms of transfer 1330. Once both parties are satisfied the ARC 200 is conveyed by the Administrator to the buyer 1350 who immediately becomes new Owner 300 with all rights of Ownership 310.

The terms of any sale 1390 for an ARC 200 are determined 100% by the buyer 1350 and seller 1340. The buyer 1350 and seller 1340 may use any form of consideration including but not limited to monetary, barter, points, nothing or any other method the buyer 1350 and seller 1340 agree appropriate.

New Ownership 300 can be any one previously outlined as an Owner 300, including but not limited to: Individual, Partnership, LLC, S-Corp, C-Corp, Trust, Limited Partnership, REIT or Government Entity ownership structure.

It is conceivable that a property 100 with an ARC 200 would be more valuable and marketable because of the buyer's 1350 ability to inspect the property's 100 records 290.

The invention does not include a mechanism for the underlying real property 100 transfer, only the ARC 200 is sold 1390.

We envision that most ARC 200 sales 1390 will coincide with real property 100 transfer. The entire ARC 200 can be sold 1390. Through this sale process 1390 Owners 200 the ability to monetize their asset.

Additionally, Certified Relationships 720 stay with the ARC 200 at sale 1390 giving the Buyer 1350, now Owner 200 a knowledgeable team who understand the property 100.

After the transaction contemplated in FIG. 16, the seller 1340 (prior Owner 300) has the right to keep a historic copy 1410 as part of the ARC 200 sale. The historic copy 1410 serves the Seller 1340 and acts as the seller's 1340 depository 240 for post transaction information 700. The historic copy 1410 retained by the seller 1340 is able to store the seller's 1340 personal information after the ARC 200 sale 1390. Examples of these Seller 1340 retained information 700 would include property 100 transaction documents, personal financial statements and tax returns.

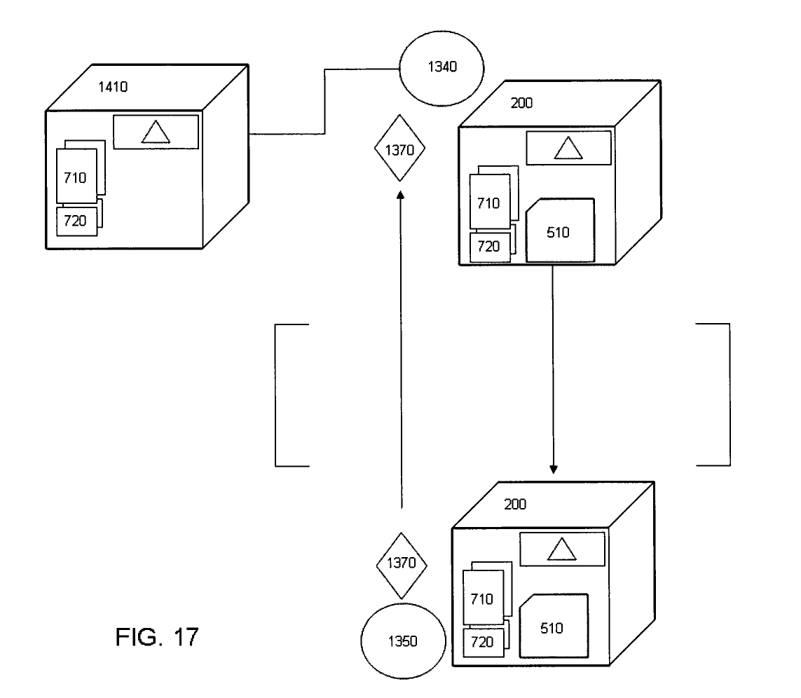

FIG. 17 is a schematic representation of the seller retaining a historic copy 1410 of the container after sale 1390. When the seller 1340 transfers the ARC 200 including property information 710, contact information 720 and certified information 510 to the buyer 1350 and receives monetary compensation 1370, a historic copy 1410 is created.

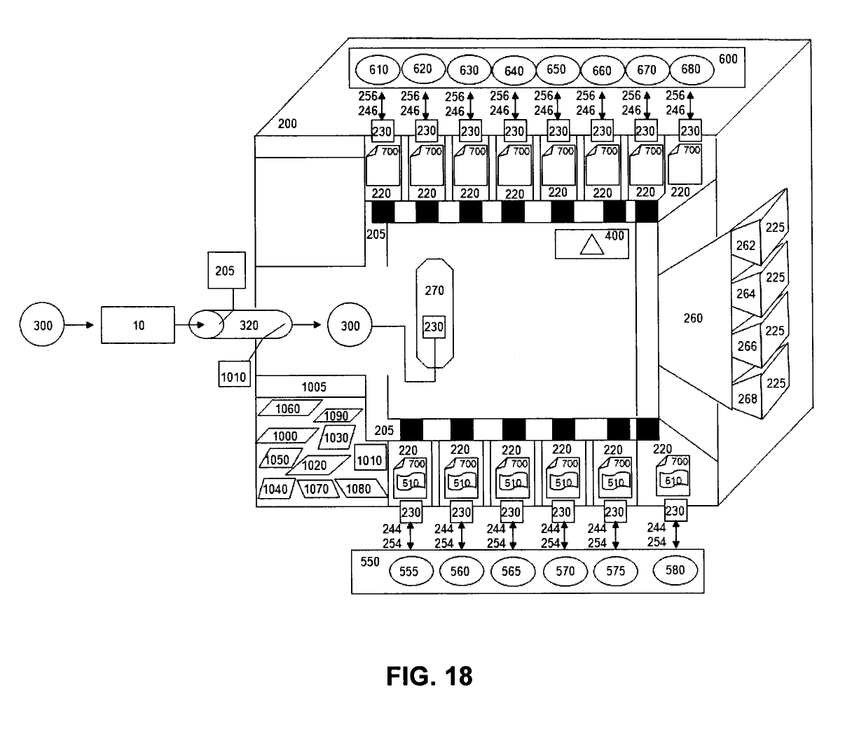

FIG. 18 shows the ARC 200. Access is provided to the Owner 300 of the ARC 200 through the Administrator 10 maintained web portal 320. The web portal 320 is comprised of a secure system of commands 205 and security applications 1010. The Owner 300 manages their ARC 200 through the Virtual Manager 270. The Access Mechanism 230 within the Virtual Manager 270, enables Owners 300 to allow Certified Practitioners 550 which include but not

limited to: Appraiser 555, Realtor® 560, Surveyor 565, Architect 570, Engineer 575 and Accountant 580 to deposit 244 and withdraw 254 certified information 510 and other information 700 into a standard organization method 220. With the same Access Mechanism 230 Owners also allow Vendors 600: Legal 610, Government 620, Lender/Bank 630, Title 640, Insurance 650, Facilities Management 660, Asset Management 670, Other Vendors 680 and Valet Services 690 to deposit 246 and withdraw 256 information 700 into a standard organization method 220. Information 700 in the standard organization method 220 is protected by Owner 300 controlled Security 205.

Using the Publisher 260 and MicroSites 225, Owners 300 can publish property information 710 and contact information 720 to public views 262, tenant views 264, prospective buyer views 266 and other views 268.

Through the Application Store 1005 Owners 300 also have the ability to purchase and integrate applications 1000 which include but are not limited to Security 1010, Analysis 1020, Tools 1030, ARC Interface 1040, Gadgets 1050, Facility Management 1060, Financial Management 1070, Property Marketing Tools 1080 and Other Applications 1090.

What is claimed is:

1. A computer system having at least a processor coupled to a memory and configured to execute an Asset Record Container (ARC) program, a secure ARC web portal program and a payment transaction processing program having computer executable instructions, the computer executable instructions adapted to be executed to implement a method for creating and interacting with an Asset Record Container, the method comprising:
providing, via the ARC program, an Asset Record Container (ARC) comprising:
providing a unique identifier container adapted to store a unique identifier representing a piece of real property;
providing an asset information container adapted to receive and store information related to the piece of real property identified by the unique identifier;
providing an ARC information transaction history adapted to store the input and output of the real property information stored by the ARC;
providing an ARC web portal manager adapted to allow the owner of the real property
represented by the ARC to manage access to the real property information stored by the ARC utilizing a plurality of ARC access rules; and
providing an ARC external application interface adapted to allow for communication with third party applications;
providing, via the ARC web portal program, a secure ARC web portal adapted to provide access to the ARC according to the plurality of ARC access rules of the ARC web portal manager; and
providing, via the payment transaction processing program, a payment transaction processing system adapted to handle receipt and payment of transaction fees relating to creating and interacting with the ARC;

2. The method of claim 1 wherein providing the asset information container further comprises:
providing a deposit management system capable of receiving and storing information that is submitted using a keyboard, fax, telephonic communication, Simple Message Service, Multimedia Messaging Service, electronic mail or File Transfer Protocol and is capable of receiving and storing information in a variety of formats including document formats, image formats, audio/video formats.

3. The method of claim 2 wherein the asset information container is further adapted to receive and store information selected from the group consisting of vendor information, practitioner information, property information and relationship information.

4. The method of claim 3 wherein providing, via the ARC program, an ARC further comprises providing an asset information conversion container adapted to convert formats of information received and stored in the ARC thereby reducing the prevalence of redundant asset information.

5. The method of claim 4 wherein providing an unique identifier container comprises proving a unique seven digit alphanumeric identifier and providing an ISO identifier based on country code.

6. The method of claim 5 wherein providing, via the ARC program, an ARC further comprises an asset information certification system adapted to receive and store asset information certification information relating to the information received and stored in the asset information container.

7. A computer program product, comprising a computer usable medium having a computer readable program code embodied therein, said computer readable program code adapted to be executed to perform operations for creating and interacting with an Asset Record Container, the operations comprising:
providing, via the ARC program, an Asset Record Container (ARC) comprising:
providing a unique identifier container adapted to store a unique identifier representing a piece of real property;
providing an asset record container adapted to receive and store information related to the piece of real property identified by the unique identifier;
providing an ARC information transaction history container adapted to store information related to the input and output of the real property information stored by the ARC;
providing an ARC web portal manager adapted to allow the owner of the real property represented by the ARC to manage access to the real property information stored by the ARC utilizing a plurality of ARC access rules; and
providing an ARC external application interface adapted to allow for communication with third party applications;
providing, via the ARC web portal program, a secure ARC web portal adapted to provide access to the ARC according to the plurality of ARC access rules of the ARC web portal manager; and
providing, via the payment transaction processing program, a payment transaction processing system adapted to handle receipt and payment of transaction fees relating to creating and interacting with the ARC.

8. The computer program product of claim 7 wherein providing the Asset Record Container further comprises providing a deposit management system capable of receiving and storing information that is submitted using a keyboard, fax, telephonic communication, Simple Message Service, Multimedia Messaging Service, electronic mail or File Transfer Protocol and is capable of receiving and storing information in a variety of formats including document formats, image formats, audio/video formats.

9. The computer program product of claim 8 wherein the Asset Record Container is further adapted to receive and store information selected from the group consisting of vendor information, practitioner information, property information and relationship information.

10. The computer program product of claim 9 wherein providing, via the ARC program, an ARC further comprising providing an asset information conversion method adapted to convert unique standard information received and stored in the Asset Record Container thereby reducing the prevalence of redundant asset information.

11. The computer program product of claim 10 wherein providing a unique identifier comprises providing a unique seven-digit alphanumeric identifier and providing an ISO identifier based on country code.

12. The computer program product of claim 11 wherein providing, via the ARC program, an ARC further comprising an asset information certification system adapted to receive and store certified asset information relating to the real property which is the subject of the Asset Record Container.

13. An apparatus for creating and interacting with an Asset Record Container comprising:
a computer system comprising at least one processor and a data store, the computer system including:
an Asset Record Container (ARC) adapted to store real property information comprising:
an Asset Record Container adapted to store a unique identifier representing a piece of real property;
an Asset Record Container adapted to receive and store information related to the piece of real property identified by the unique identifier;
an ARC information transaction history record adapted to store information related to the input and output of the real property information stored by the ARC;
an ARC web portal manager adapted to allow the owner of the ARC to manage access to the information stored by the ARC utilizing a plurality of ARC access rules;
and an ARC external application interface adapted to allow for communication with third party applications;
a secure ARC web portal adapted to provide access to the ARC according to the plurality of ARC access rules of the ARC web portal manager; and
a payment transaction processing system adapted to handle receipt and payment of transaction fees relating to creating and interacting with the ARC.

14. The apparatus of claim 13 wherein the Asset Record Container further comprises:
a deposit management system capable of receiving and storing information that is submitted using a keyboard, fax, telephonic communication, Simple Message Service, Multimedia Messaging Service, electronic mail or File Transfer Protocol and is capable of receiving and storing information in a variety of formats including document formats, image formats, audio/video formats.

15. The apparatus of claim 14 wherein the Asset Record Container is capable of receiving and storing information selected from the group consisting of vendor information, practitioner information, property information and relationship information.

16. The apparatus of claim 15 wherein the ARC further comprises an asset information conversion method adapted to convert formats of information received and stored in the Asset Record Container thereby reducing the prevalence of redundant asset information.

17. The apparatus of claim 16 wherein the unique identifier comprises a unique multi-digit alphanumeric identifier and an ISO identifier based on country code.

18. The apparatus of claim 17 wherein the ARC further comprises an asset information certification system adapted to receive and store certified asset information relating to the information in the Asset Record Container.
